(19) United States
(12) Patent Application Publication
(10) Pub. No.: US 2002/0167548 A1
(43) Pub. Date: Nov. 14, 2002

(54) Method, system, and computer-program product for the customization of drop-down list boxes using hot lists

(76) Inventor: La Tondra Murray, Durham, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 09/855,109

(22) Filed: May 14, 2001

(51) Int. Cl. G06F 3/00

(52) U.S. Cl. 345/825; 345/811

(57) ABSTRACT

The invention is a customizable “hot list” used in connection with drop-down list boxes on web-based forms. The customizable hot list appears on the user's screen when activated, e.g., when a drop-down list box is clicked with the right mouse button. This hot list presents a subset of the items contained within the drop-down list box, as selected by the user. The contents of the hot list may be determined entirely by the user via configuration of a “Preferences” menu option.

### BACKGROUND OF THE INVENTION

1. Field of the Invention

The present invention relates to improved methods, systems, and computer program products for displaying a list of sections from a drop-down menu to a user of the method, system, or computer program product.

2. Description of the Related Art

The ubiquity of the desktop Graphic User Interface (GUI) and the World Wide Web has made the usage of forms common for a variety of application domains. Users use GUIs to configure applications and manipulate object properties. Users likewise utilize web-based forms on the Internet to purchase items, complete surveys, submit requests for product information, customize applications, or conduct searches.

When using such GUIs, users may enter information that they change frequently (e.g. font) or infrequently (e.g. state or country as required for a mailing address) from a long drop-down list box containing many (i.e. more than 15) items. FIG. 1a illustrates an example of a typical GUI selection box 100 which solicits information from the GUI user (in this example, it is presenting the user with the opportunity to select their state from a drop-down menu). In FIG. 1a, the drop-down menu is in the closed state. In its closed state, the control displays the current value (e.g., North Carolina). A “data input box arrow button” 102 on the right side of a data input box 104 directs a user of the GUI to manipulate (e.g., “left-click”, using the left mouse button) arrow button 102 to display a preset selection list from which the data entry in data entry box 104 will be selected.

FIG. 1b illustrates the drop-down menu of FIG. 1 in the open position. As can be seen, a list of selections appears in a drop-down box 106 below the data input box 104. An up button 108 and down button 110 gives the user the ability to scroll through the list of selections in a known manner.

In some cases (including the example illustrated in FIG. 1b), drop-down list boxes are not enabled to make use of keyboard shortcuts (e.g. typing the first letter of the item in question such that the focus jumps to the desired menu element). Thus, users must scroll through the entire list to select the appropriate element each time that they use the form. This process can be time-consuming and/or error prone, particularly if the form contains several GUI selection boxes, each having a drop-down list box containing many items.

Drop-down list boxes as presented on web-based forms and in many desktop GUIs have no inherent mechanisms for the collection of data about their usage within or across application sessions, thus requiring the user to potentially have to navigate through all of the selections within the list to find the desired selection, each and every time.

Various applications “remember” recently used files. For example, word processors such as Microsoft Word and WordPerfect store a list of a limited number of recently used files that have been opened or saved. The names of these saved files are added at the end of a drop-down menu such as the File menu associated with the name “File” on a horizontal bar of the main application window. This is a quick way of identifying to the user certain used files which now can be reopened and reaccessed by electing (as by single or plural mouse clicking, for example) an entry in the menu corresponding to the file name. The order and content of the lists of recently used files are controlled by the application, e.g., the word processor.

Accordingly, it would be desirable to provide a GUI with drop-down list boxes that have a display which is modified based on historical knowledge about the users' previous selections, and that allows the user to determine the contents of the drop-down list as appropriate for their task.

### SUMMARY OF THE INVENTION

The present invention is a customizable “hot list” used in connection with the dropdown list boxes on web-based forms. The customizable hot list appears on the user's screen when activated, e.g., when a drop-down list box is clicked with the right mouse button. This hot list presents a subset of the items contained within the drop-down list box, as selected by the user. The contents of the hot list is determined entirely by the user via configuration of a “Preferences” menu option.

### BRIEF DESCRIPTION OF THE DRAWINGS

FIG. 1a is illustrates an example of a typical GUI selection box with a drop-down menu in a closed state;

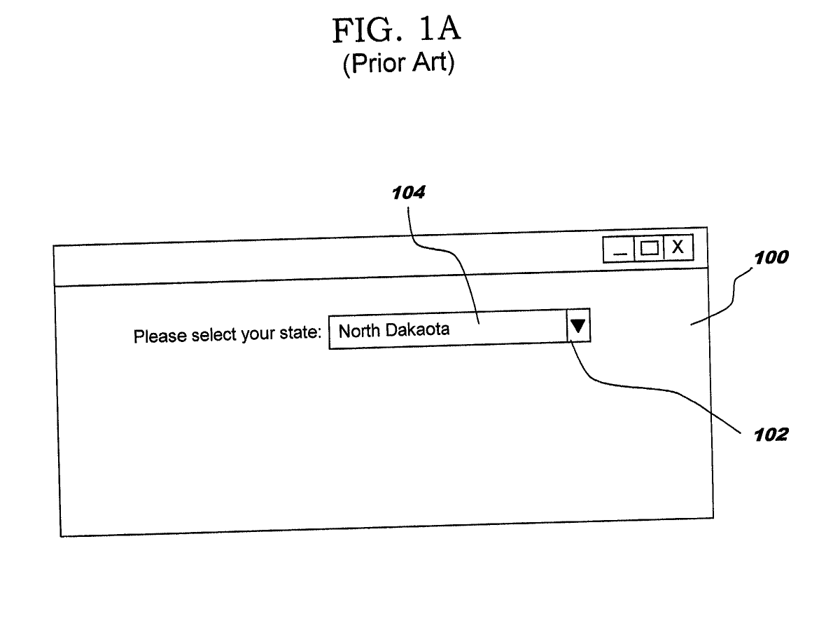

FIG. 1b illustrates an example of a typical GUI selection box with a drop-down menu in an open state;

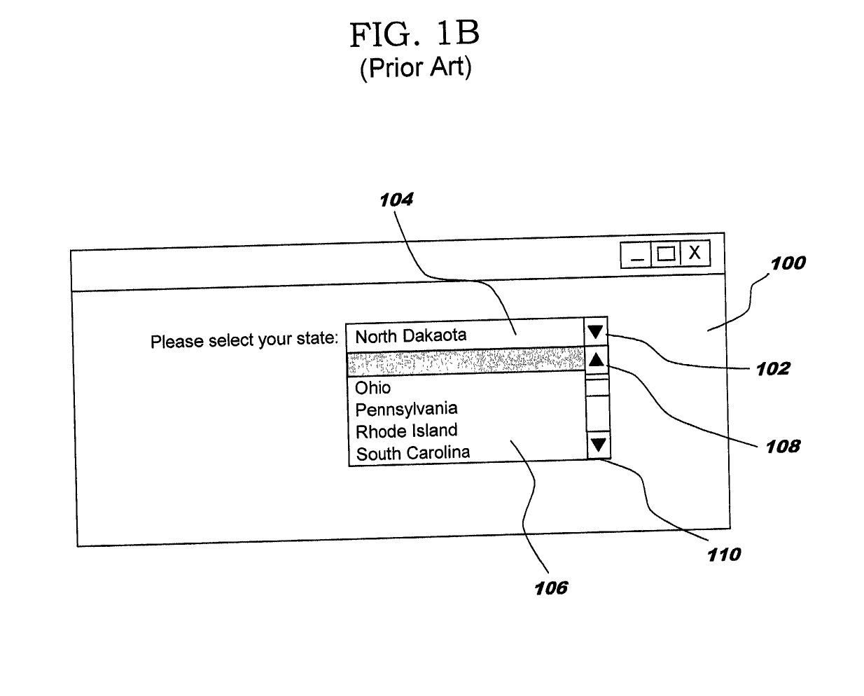

FIG. 2 illustrates an example of an implementation of a hot list activatable from a selection box in accordance with the present invention;

FIG. 3 illustrates a representation of an example of a preferences panel in accordance with the present invention;

FIG. 4 illustrates an example of a dialog box utilized in connection with the present invention; and

FIG. 5 is a flowchart illustrating the basic steps of the present invention.

### DETAILED DESCRIPTION OF THE PREFERRED EMBODIMENTS

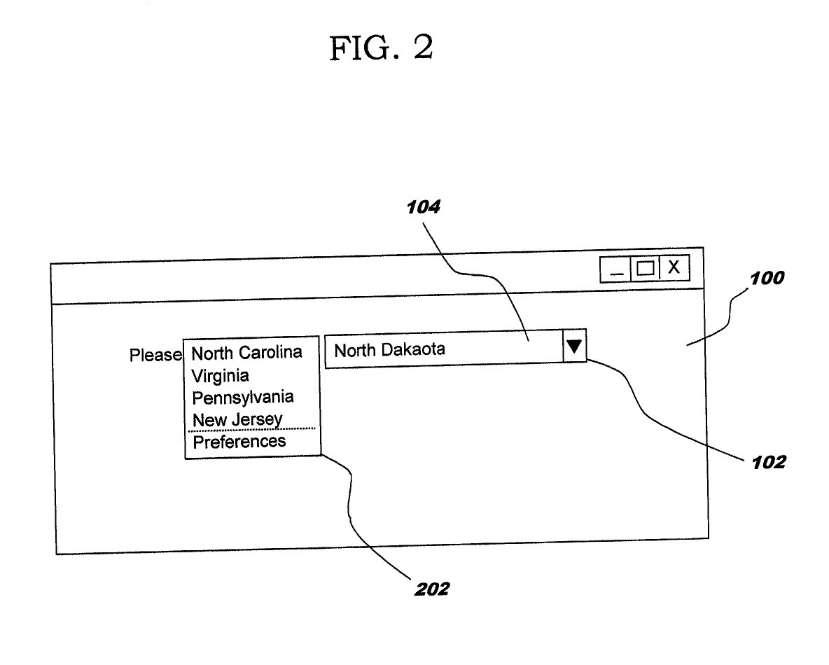

FIG. 2 illustrates an example of an implementation of the present invention. Specifically, the selection box 100 has been enhanced by adding “hot-list” functionality so that, upon appropriate manipulation by the GUI user, a hot list 202 is displayed in the selection box 100. Hot list 202 is displayed upon activation by a user, e.g., when the user of the GUI “right-clicks” the down arrow button 102. Rather than displaying the entire drop-down list for the user to scroll through, instead the user is presented with a hot list comprising a subset of the items contained in the drop-down list. For example, the data displayed in hot list 202 might be displayed based upon frequency of use, recency, or a user-selected “custom” list which displays a subset of the drop-down list items based upon options defined by the user.

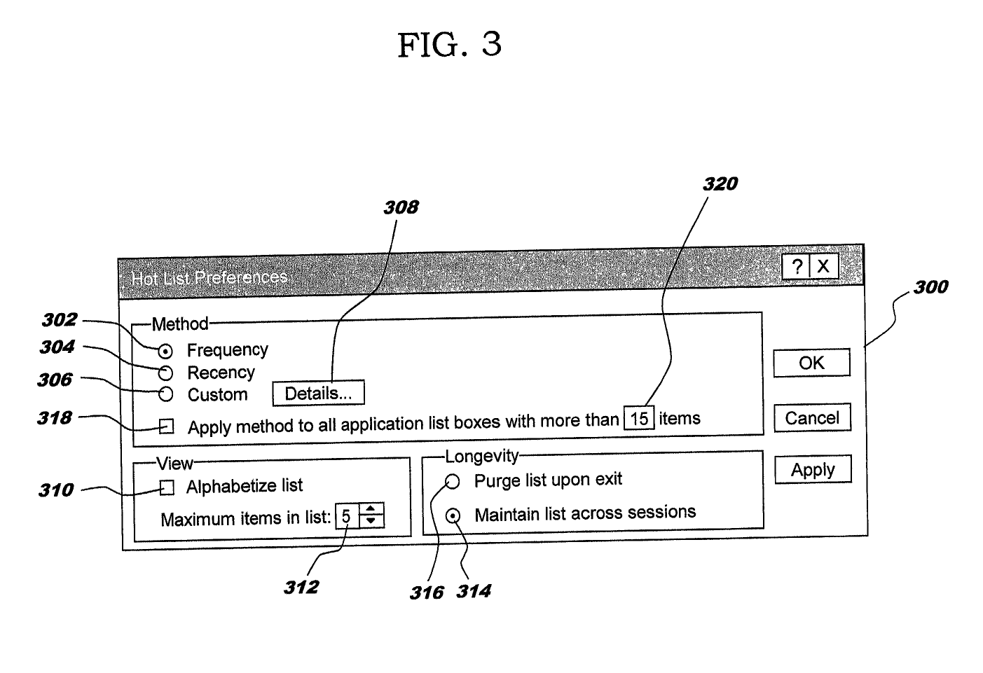

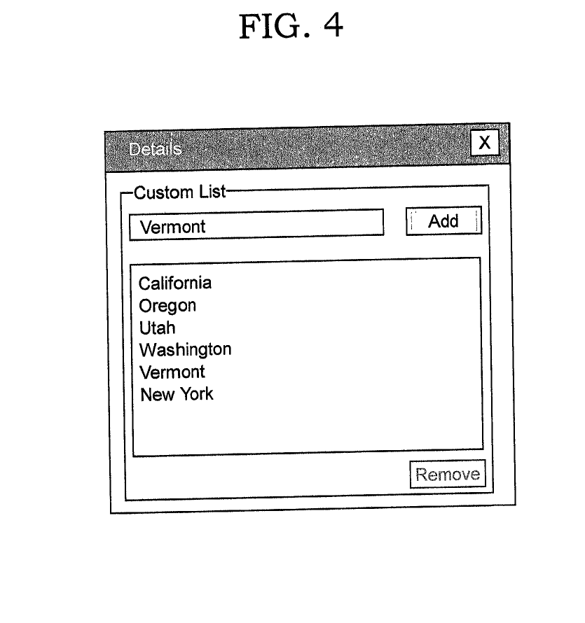

One of the available selections from the hot list 202 is “Preferences”. Users will use the “Preferences” panel to select the type of historical data that they would like to view in the hot list. A representation of an example of a preferences panel 300 in accordance with the present invention is presented in FIG. 3. The available data types may include: frequency (302) (the subset of menu options that are most frequently selected), recency (304) (the subset of menu options that are most recently selected), and custom (306) (a subset of menu options as defined by the user). To specify the details of a custom method, the user selects the “Details” button 308 and an additional dialog box 400 is displayed as illustrated in FIG. 4. Dialog box 400 enables the user to create a list of items that will appear in the hot list. As an example, a user could elect to use the custom method if a web-based form consistently required the entry only of states on the East Coast of the United States. In the example of FIG. 4, by highlighting “Vermont” from a selection list 402, the highlighted selection is displayed in a data input box 404. By manipulating (e.g., “right-clicking”) the “Add” button 406, Vermont is added to the custom hot list. This process is repeated for each selection that the user wishes to add to the hot list. The custom method would be most useful when users know what subset of menu selections they are likely to use before they begin their tasks.

The user can also select the view of the hot list display. For example, the user can select the alphabetized selector 310 or can specify the maximum number of items to display using selection box 312. The maximum number of items displayed in the hot list is preferably limited, with the exact number to be determined by the user. Limiting the number increases the usefulness of the hot list, since it is desirable to limit the number of available choices to the user so that they do not have to go through a long list of selections. Users will additionally be able to configure the behavior of the hot list to span individual application sessions if required. In some cases, users may want to preserve the contents of a hot list from day to day. This could be especially important for users who perform the same tasks within the same application over a span of several days or weeks. These users may want to examine how the contents of a particular hot list evolves over a given time period to determine which selections are most popular or important. For example, checking box 314 maintains the list across sessions; alternatively, by selecting box 316, the list is purged upon exiting the program. User can, therefore, opt to pick up where they leave off by using existing hot lists or alternatively, create new hot lists each time they use a particular application. The preferences panel may also provide a “configure one, apply to all” option that will enable users to specify the data collection method for one list box at a time or for a group of list boxes throughout the application.

In addition, by checking box 318 and selecting a number in box 320, the user can select the number of items that must appear in a drop-down box before the user-selected method is applied. All of the above-described preferences are given by way of example; obviously many other preferences may be selectable and still fall within the scope of this invention.

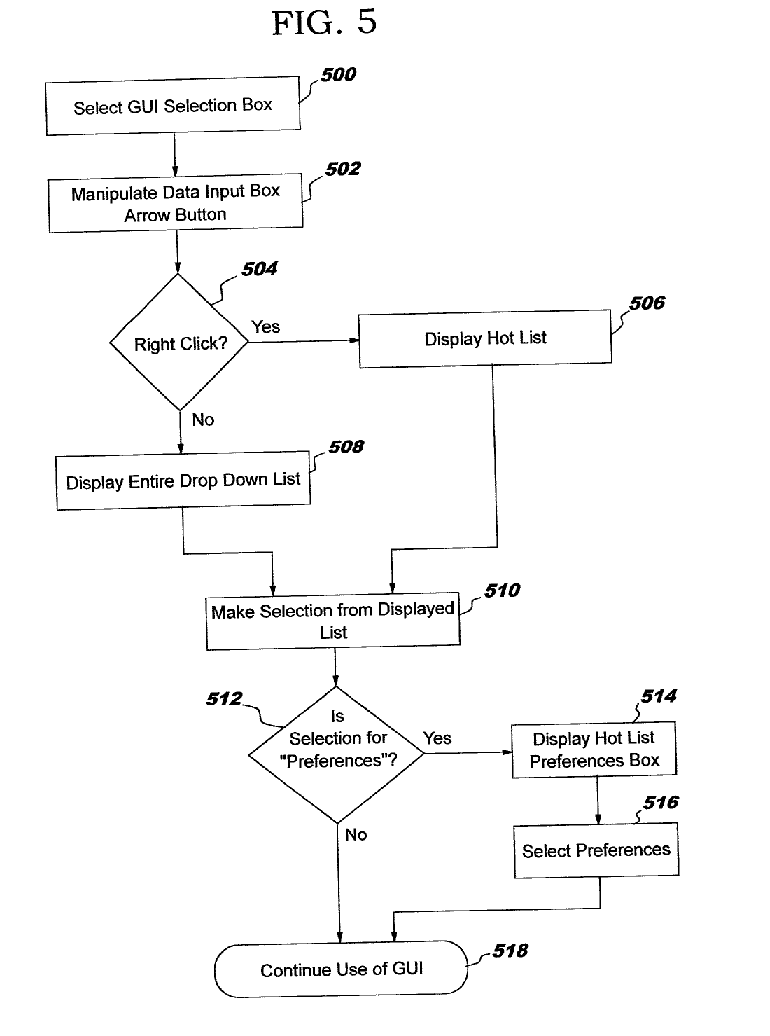

FIG. 5 is a flow chart illustrating the basic steps of the present invention. In step 500, a user selects a GUI selection box in a well-known manner, and the selection box is displayed. In step 502, the user manipulates the data input box arrow button by, for example, maneuvering the cursor over the arrow button and then either right-clicking or left-clicking the mouse buttons.

At step 504 a determination is made as to whether or not the user has right clicked the mouse button. If the user has right-clicked the mouse button, at step 506 the hot list is displayed.

If, on the other hand, the user has not right clicked the arrow button, then it is presumed that the user has left clicked the arrow button, and the entire drop down list is displayed at step 508.

At step 510 the user selects from either the entire drop down list or the hot list, depending upon which mouse button was utilized to manipulate the data input box arrow button.

Next, at step 512, a determination is made as to whether or not the selection is for “preferences”. If the selection is for preferences, at step 514 the hot list preferences box is displayed and at step 516 the user selects the desired preferences. Control is then returned to the GUI at step 518.

Alternatively, if at step 512 it is determined that the selection is not for preferences, then the process is complete and control is returned to the GUI at step 518.

The above-described steps can be implemented using standard, well known programming techniques. The novelty of the above-described embodiment lies not in the specific programming techniques which are used to create and allow manipulation of the program, but in the use of the steps described to achieve the described results. Further, software programming code which embodies the present invention is typically stored in permanent storage of some type. In the client/server environment, such software programming code may be stored in storage associated with the server. The programming code may be embodied on any of a variety of known media for use with a data processing system, such as a diskette, a hard drive, or CD-ROM. The code may be distributed on such media, or be distributed to users from the memory or storage of one computer system over a network of some type to other computer systems for use by users of such other systems. The techniques and methods for embodying software program code on physical media and/or distributing software code via networks are well known and will not be further discussed herein.

The methodology for the customization of drop-down list boxes will enable users to browse and complete forms faster and more efficiently, particularly when the same forms are completed repeatedly. Drop-down list boxes are particularly valuable for desktop GUIs and web applications because they conserve screen area while presenting users with several options on demand. While Microsoft presents users with the most recent items selected from a drop-down menu (as in the case of fonts), the hot list solution allows users to effectively customize any particularly lengthy drop-down list boxes as appropriate within an application. The drop-down list box thus becomes a more useful tool, personalized to accommodate trends in the user's current tasks and/or performance. This invention additionally has implications for the creation of “smarter” user interface tools that can be dynamically configured based on analyses of user selections for both desktop and web-based offerings.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. An improved graphical user interface (GUI) having a GUI selection box capable of displaying a selection set of items when a selection button is manipulated in a first manner, the improvement comprising:
a hot list box displaying a subset of items from said selection set of items when said selection button is manipulated in a second manner.

2. An improved GUI as set forth in claim 1, wherein said subset of items displayed in said hotlist box is selectable by a user of said GUI.

3. An improved GUI as set forth in claim 2, wherein said subset of items displayed in said hot list is displayed in an order selectable by the user.

4. An improved GUI as set forth in claim 2, wherein a quantity of items displayed in said hot list box is selectable by the user.

5. An improved GUI as set forth in claim 2, wherein a method of determining which of said items from said selection set are to be displayed in said hot list is selectable by the user.

6. An improved GUI as set forth in claim 5, wherein said method of determining which of said items from said selection set are to be displayed in said hot list comprises listing the most recently selected items.

7. An improved GUI as set forth in claim 5, wherein said method of determining which of said items from said selection set are to be displayed in said hot list comprises listing the frequently selected items.

8. An improved GUI as set forth in claim 5, wherein said method of determining which of said items from said selection set are to be displayed in said hot list is applied to said hot list only after a predetermined number of items are to be displayed in said hot list.

9. A method of providing a computer graphical user interface, utilizing a screen interface and a pointing device controlling a pointer, to perform a plurality of related functions, comprising:
selecting a selection box through the appropriate positioning and manipulation of the pointer by way of said pointing device, said selection box configured to display a selection set of items;
selecting a hot list box through the appropriate positioning and manipulation of said pointer with respect to said selection box, said hot list box configured to display a subset of the items displayable in said selection set; and
selecting at least one of said items from said subset using said pointing device.

10. The method of claim 1, wherein said hot list box is selected by right-clicking a button on said selection box using said pointing device.

11. A computer program product including a graphical user interface (GUI) comprising:
a computer-readable storage medium having computer readable program code means embodied in said medium, said computer readable program code means comprising:
computer instruction means for displaying a selection set of items when a selection button is manipulated in a first manner; and
a hot list box displaying a subset of items from said selection set of items when said selection button is manipulated in a second manner.

12. A computer program product as set forth n claim 11, wherein said subset of items displayed in said hotlist box is selectable by a user of said GUI.

13. A data processing system comprising:
a display area;
a pointing device; and
a graphical user interface (GUI) further comprising:
means for displaying a selection set of items when a selection button is manipulated in a first manner; and
a hot list box displaying a subset of items from said selection set of items when said selection button is manipulated in a second manner.

14. The data processing system of claim 13, wherein said subset of items displayed in said hotlist box is selectable by a user of said GUI.
